(19) United States
(12) Patent Application Publication
(10) Pub. No.: US 2017/0235907 A1
(43) Pub. Date: Aug. 17, 2017

(54) REMOTE HEALTHCARE SYSTEM FOR FAMILY CARE

(71) Applicants: Kersti A. Peter, Concord, CA (US); David B. Miller, Orinda, CA (US); William M. Hess, Pinole, CA (US)

(72) Inventors: Kersti A. Peter, Concord, CA (US); David B. Miller, Orinda, CA (US); William M. Hess, Pinole, CA (US)

(21) Appl. No.: 15/256,491

(22) Filed: Sep. 2, 2016

Related U.S. Application Data
(60) Provisional application No. 62/283,962, filed on Sep. 16, 2015.

(51) Int. Cl. G06F 19/00; H04M 7/00; G08B 25/00; G08B 21/04; H04L 12/28

(52) U.S. Cl. CPC G06F 19/3418; G08B 21/0446; G08B 21/0453; H04L 12/2818; H04L 12/2825; G08B 25/008; H04M 7/003; H04M 2242/04; G06F 3/04817

(57) ABSTRACT

A remote healthcare system that incorporates a cloud based platform with a service provider having servers that store data and administrative applications for delivering healthcare features to a care recipient by an authorized member of a caretaker group where the system includes a care recipient controller at the location of the care recipient being provided the healthcare features, the care recipient controller being under primary control of the care recipient and having an internal microcontroller programmed to function as a general purpose computer to permit communications with cloud platform systems and with the care recipient, wherein the controller has circuitry to connect wirelessly and by landline to authorized members of the caretaker group, such that one authorized member of the caretaker group can remotely take control of the recipient controller as authorized by the service provider, and remotely control services to the care recipient including initiating emergency calls to 911 through the controller switch circuitry for the care recipient's landline.

### CROSS-REFERENCE TO RELATED APPLICATIONS

This non-provisional utility application claims the priority date of the filed provisional application Ser. No. 62/283,962 filed Sep. 16, 2015.

### FEDERALLY SPONSORED RESEARCH

Not Applicable

### SEQUENCE LISTING OR PROGRAM

Not Applicable

### FIELD OF INVENTION

The present invention relates to a remote healthcare system that is particularly adapted for family care that is inclusive of family members and close friends as well as professionals in the health care business.

### BACKGROUND OF INVENTION

The desire for independent living by elders, the infirm, or those who can benefit from remote healthcare has prompted healthcare providers to adopt solutions that are effective in personalizing the healthcare to the individual client. By means of cloud computing, personalized healthcare can be provided with a minimal financial burden. Savings in physician time as well as allowing real time, face-to-face consultations with a patient, while the patient remains at home or in a general care facility justify the hardware and system operation costs. Adoption of remote healthcare systems provides real savings to both the professional healthcare provider and the client patient.

Communication systems utilizing cloud computing enable a single healthcare provider to remotely engage all its enrolled patients using simple systems that take advantage of modern smartphones and touch screen tablets. The complexity of such systems increases exponentially when access is provided not only to healthcare professionals, but members of the family of the client patient, and others who may have an interest in the care of the client patient. As the communication systems become more personalized to the client patient the remote healthcare system can integrate its system with the communication systems that have become commonplace with the use of tablets and smart phones by young and old alike.

### SUMMARY OF THE INVENTION

The remote healthcare system of this invention is particularly adapted for family care that is inclusive of both healthcare providers and the family and friends of the healthcare receiver. The healthcare receiver may be a client patient or simply an elder that desires to maintain a degree of independent living with the help of others. The focus is healthcare receiver centric. The healthcare system of this invention is most suitable for mobile tablets with an intuitive touch screen interface. From the healthcare receiver's end, touchscreen icons are preferably arranged in a matrix format forming a control panel. This feature enables a compact grid of multiple mnemonic icons to be formed in the control panel of the touch screen tablet. The icons, which comprise portals to the various controls, services and information available to the healthcare receiver as a service provider client, are simple and easily recognizable even on the smaller touch screen of a mobile tablet or smart phone. Notably, the healthcare receiver need not subscribe to the complete set available and a base set with an extended set may be offered using the healthcare system of this invention.

### BRIEF DESCRIPTION OF THE DRAWINGS

FIG. 1 is a diagrammatic overview of the remote healthcare system of this invention.

FIG. 2 is diagrammatic view of a user interface for the care recipient and the caretaker group.

FIG. 3 is a block diagram of a central controller in a care recipient control box.

FIG. 4 is a block diagram of a combined tablet and custom amplifier in an external casing.

FIG. 5 is a front view of the external casing of FIG. 4.

FIG. 6 is a flow chart for the procedure for remote dialing of 911 through the care recipient landline.

FIG. 7 is a schematic of an exemplar chip set for the remote dialing feature and the custom amplifier in the care recipient control box.

### DETAILED DESCRIPTION OF THE PREFERRED EMBODIMENT

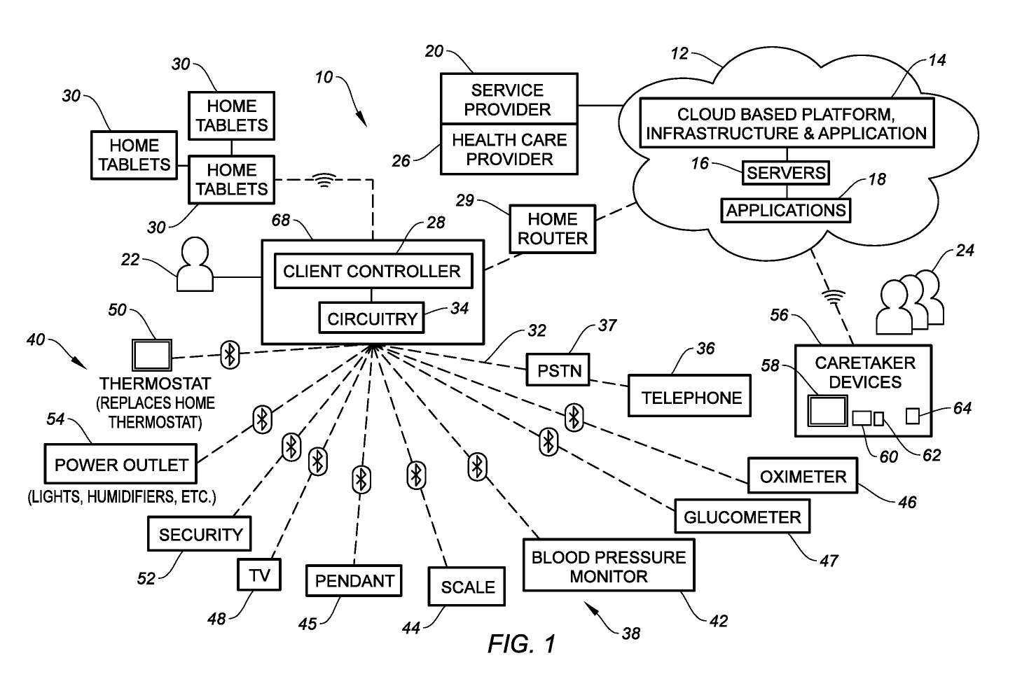

Referring to FIG. 1, the remote healthcare system of this invention is designated generally by the reference numeral 10. The healthcare system 10 includes both hardware and software features and is dependent on the cloud 12 having a cloud-based platform 14. The cloud-based platform 14 includes infrastructure in the form of servers 16 and administrative applications 18 typically run by the service provider 20. The servers 16 and applications 18 include a system database and the software to run client applications among the multiple caretakers and typically multiple care recipients. For simplicity, the healthcare system 10 described will consider one care recipient 22 and one caretaker group 24. Typically, the caretaker group 24 includes the service provider 20 that administers the program when that service provider is also a primary healthcare provider 26 for the care recipient. However, the service provider 20 may not be the primary health care provider for the care recipient 22 and may simply administer the cloud-based platform for the remote healthcare system 10 with the active participation of the primary healthcare provider 26 or simply a primary member of the caretaker group 24.

In the schematic diagram of FIG. 1, the hub of the remote healthcare system 10 from the perspective of the care receiver 22 is a compact central controller 28 in the recipient's local environment, such as the care recipient's home. The care receiver's central controller 28 is connected by hardwire or wirelessly to a home network router 29, which in turn connects to the cloud 12 and particularly to the cloud-based platform 14 administered by the service provider 20. In addition, the care receiver's central controller 28 communicates wirelessly with one or more mobile touchscreen tablets 30 that may be portable or mounted at strategic locations in the home.

Importantly, the central controller 28 connects to a telephone landline 32 and includes circuitry 34 to bypass a connected telephone 36 for communication over the public switched network. In addition to providing direct landline communication, the circuitry 34 enables communication when the telephone is inadvertently or accidentally left “off the hook.” Also, the circuitry 34 of the central controller 28 enables the tablets 30 that are installed with enhanced speaker and volume control to function as an annunciator when a caretaker in the caretaker group 24 seeks to communicate with the care recipient 22. Importantly, the enhanced speaker and volume control component described later, is of particular advantage when the care recipient 22 is elderly and/or hearing impaired.

The control features of the central controller 28 preferably use Bluetooth wireless for connecting to a number of health monitoring sensors 38 and controlled appliances 40. Among the health monitoring sensors 38 are a blood pressure monitor 42 for checking blood pressure, a scale 44 for checking weight fluctuations, an accelerometer pendant 45 for tracking activity and alerting caretakers of falls and/or extended periods of lack of movement, an oximeter 46 for determining pulse and blood oxygen levels, and a glucometer 47 for determining blood sugar levels. Other health monitoring devices may be added as the medical conditions of the care recipient 22 requires.

Among the controlled appliances are a remotely controlled television 48 for allowing remote command of the television, a smart thermostat 50 for monitoring and regulating the home temperature, and a security system 52 for providing remote monitoring, remote activation, deactivation and monitoring for alarms. In addition, one or more Bluetooth controlled power outlets 54 for controlling other appliances such as lights, humidifiers, clock alarms and controllable devices typical in a modern home.

In the schematic diagram of FIG. 1, the distributed network of the remote health care system 10 from the perspective of the caretaker group 24 is a wireless connection to the cloud-based platform 14 by a plurality of conventional cloud access devices 56, including personal computers 58, tablets 60 and smartphones 62. The access devices 56 include or are loaded with a software access application 64 providing controlled access, preferably wireless, to the cloud-based platform 14.

In the preferred family care focus of the remote healthcare system 10 the care recipient 22 designates the level of access for each member of the caretaker group 24. In this manner, a friend will likely have less access than a physician to medical records, tests and other health-related information. However, to minimize professional care and its expense, a family member may have the least restricted access of any member of the caretaker group 24. So long as the care recipient 22 is in command of his or her faculties, the care recipient 22 has greatest access and control and can designate the levels of access of each member of the caretaker group 24.

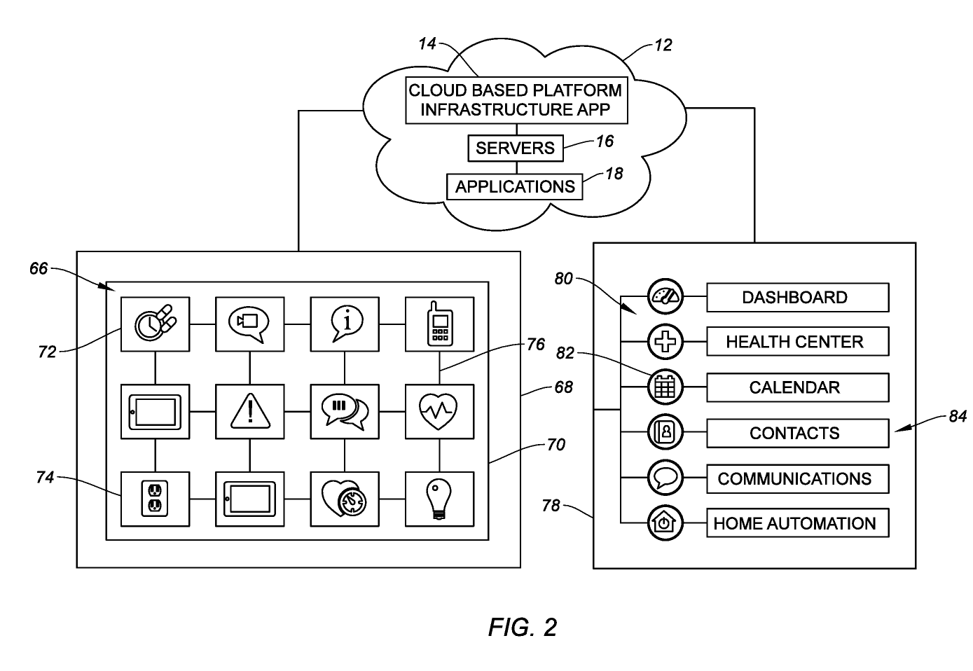

Referring now to FIG. 2, a preferred user interface 66 is illustrated for the client central controller 28, which is part of a care recipient control box 68 of FIG. 1, that preferably includes a display screen 70 as depicted in FIG. 2. It is to be understood, that as a central controller 28, the control box 68 may dedicate one of the many touch screen tablets 30 as its display screen. In this manner, an upgrade and/or replacement of a tablet 30 is a less expensive alternative than replacing the control box 68. The tablet 30 may be mounted on the control box 68 as an attached component and connected by hardwire to eliminate potential rf (radio frequency) interference. Alternately, the control box 68 includes its own dedicated display screen 70.

As shown in FIG. 2, the user interface 66 for the client central controller 28 is programmable and has a matrix 72 of user-friendly icons 74. The icons 74 are arranged in the matrix 72 for compactness, allowing a large number of large, easily visible and understandable icons 74 on the limited screen area of a tablet or smartphone. The icons 74 provide a touch control for the features depicted.

The icon matrix 72 also may include pathways 76 that indicate links between or among the various icons 74. The pathways or links 76 and the arrangement of icons 74 are adjustable to illustrate pertinent relationships among the icons 74.

Also shown in FIG. 2, is a simplified user interface 78 for the caretaker group 24. A list 80 of user-friendly icons 82 provides general access to the listed portals 84. As noted the listed portals 84 are all preferably available to the family member of the caretaker group 24 having the primary responsibility for the health care recipient 22. Depending on the nature of the professional care, the professional health care member or members of the caretaker group 24 have a controlled access that may be as extensive as the family member of the caretaker group 24. Typically, a friend member of the caretaker group 24 may have only limited access, for example to the dashboard, calendar, and communications part of the listed portals 84. Features in the dashboard may be further limited to access, preferably by the care recipient 22 or the principal family member of the caretaker group 24.

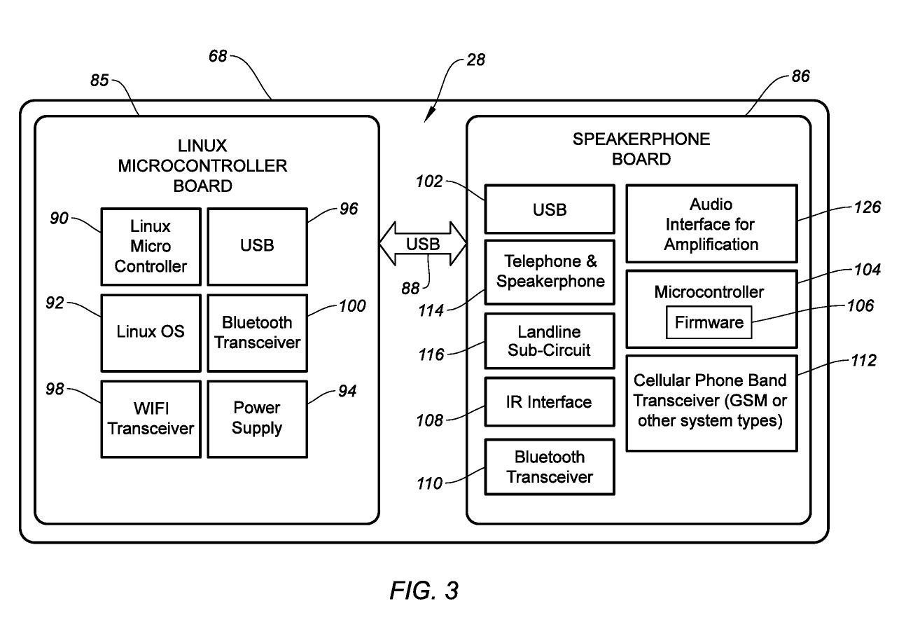

In the block diagram of FIG. 3, the central controller 28 in the control box 68 is divided into two sections, the Linux (or other operating system) microcontroller board 85 and the speaker and phone board 86. The microcontroller board 85 and the speaker and phone board 86 are in communication by a USB connection 88. The microcontroller board 85 preferably includes a Linux microcontroller 90 having a Linux operating system or OS 92 with a power supply 94 and communication modules including a USB module 96, a WiFi transceiver 98 and a Bluetooth transceiver 100. Communication with the cloud 12 by Ethernet line (not shown) may also be made in a conventional manner.

The speaker and phone board 86 includes a USB module 102 that facilitates direct connection and communication with the USB module 96 of the microcontroller board 85. The speaker and phone board 86 also includes a microcontroller module 104 with embedded firmware 106 and an IR interface module 108, a Bluetooth transceiver module 110 and a cellular phone band transceiver module 112 (GSM or other system types).

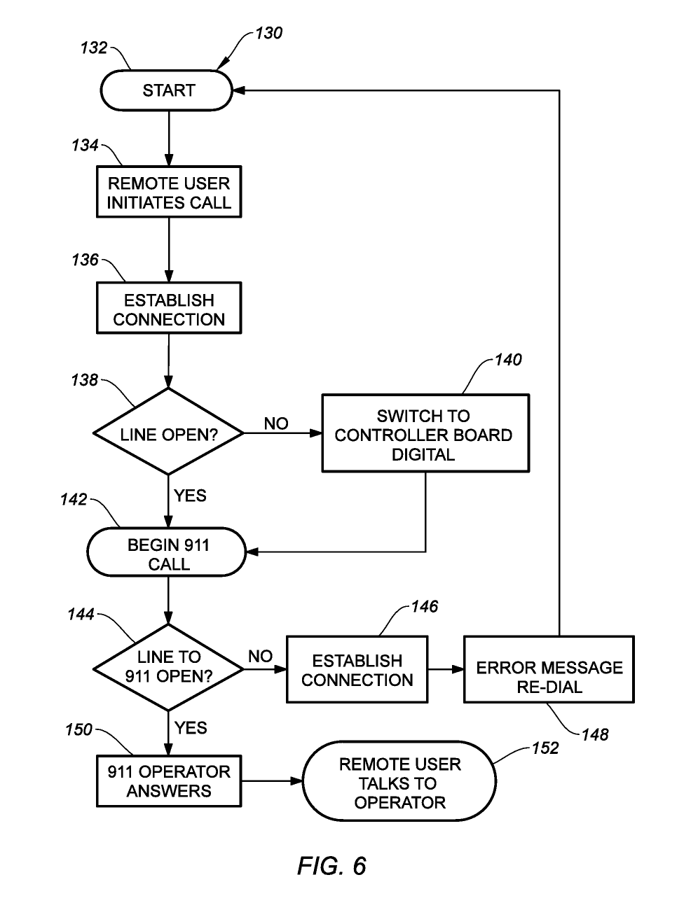

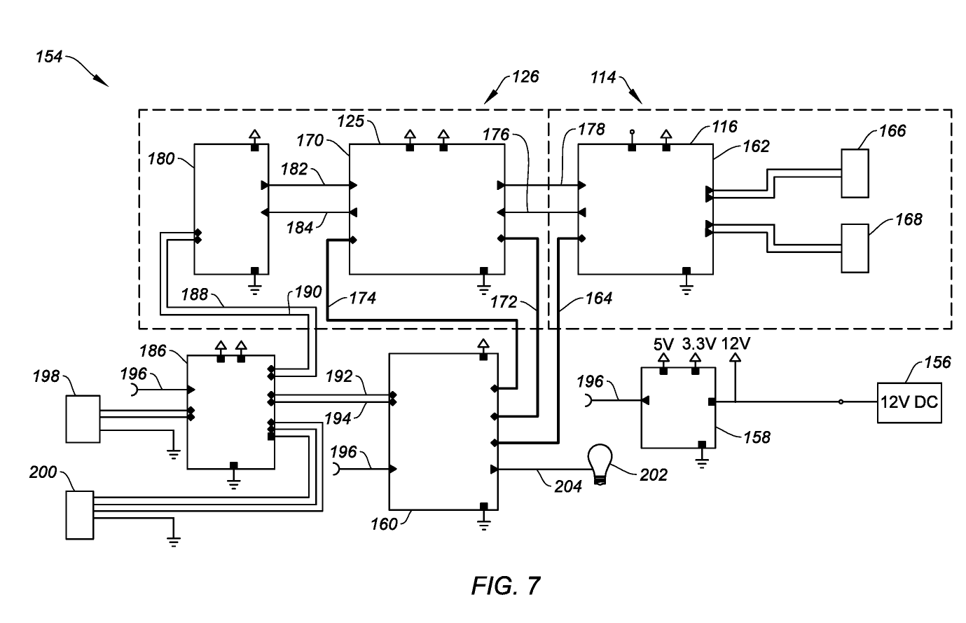

Also included is an audio amplifier module 126 and a telephone control module 114. As noted, the circuitry 34 in the central controller 28 includes the custom circuitry for emergency communications through the telephone landline 32. The part of the circuitry 34 for the telephone control module 114 includes switch sub-circuitry 116 that detects when the telephone landline 32 is interrupted or disconnected by a telephone 36 being “off hook.” This switch sub-circuitry 116 and the attendant software are described further in FIGS. 6 and 7.

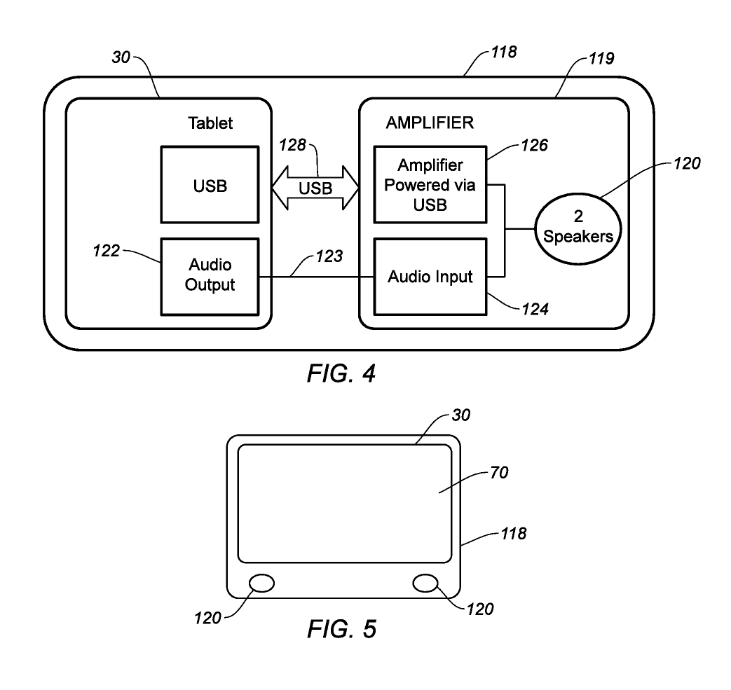

Referring to FIGS. 4 and 5, a tablet 30 having a touch sensitive display screen 70 has an external casing 118 that encloses the tablet 30 and an amplifier 119 with a pair of auxiliary amplifier speakers 120. Within the casing 118 the stock audio output module 122 of the tablet 30 is connected by USB connection 123 to an audio input module 124 that is amplified by an audio amplifier sub-circuitry 125 of the audio amplifier module 126 within the audio amplifier 119 to drive the added speakers 120. The custom audio amplifier module 126 is powered by a USB connection 128 to the tablet 30.

It is to be understood that the mobile tablets 30 are typically battery powered. The stationary mounted tablets including the tablet mounted to the control box 68 may be powered by a conventional wall connected, low-voltage power transformer (not shown). The stationary mounted tablets may use the internal battery power of the tablets or a backup battery in the event that normal household power is interrupted.

Referring now to FIG. 6, a flow chart 130, defines the procedure for enabling the emergency call to 911 for assistance when the care recipient 22 is not responsive and the care recipient's telephone line 32 appears to be busy. If an authorized member of the caretaker group 24 believes that the care recipient's connected telephone 36 may be inadvertently or accidentally “off the hook,” then the override procedure may be initiated.

From the start 132 the remote user initiates the remote 911 call procedure through the web interface in the browser via his or her caretaker device 56, such as a computer 58, tablet 60 or smartphone 62 at block 134. The authorized member of the caretaker group 24 in one alternative can initiate the 911 emergency call application even when the care recipient's telephone may be on the hook, but the care recipient does not respond to conventional calls.

The remote 911 call application available to the authorized member of the caretaker group 24 via the cloud based platform 14 establishes a connection with the client controller 28 through the central controller board 85 in the care recipient's control box 68 in procedure box 136. In decision box 138 the controller board routes the request to the control circuitry 34 in the speakerphone board 86.

The specialty sub-circuitry 116 in the speakerphone board 86 analyzes the state of the telephone line 32. If the telephone line 32 is confirmed to be not available or not “open” to receive calls, then in block 140 the procedure invokes a switch to the digital telephone procedure in the sub-circuitry to mimic a 911 phone call at procedure block 142. Alternately, the step can be omitted when all calls using the authorized 911 emergency procedure automatically invoke a switch in the sub-circuitry 116 to bypass the line to the telephone 32.

At box 144 the sub-circuitry 116 checks to see if the care recipient's landline to the 911 operator is open and available to make an emergency 911 call.

If the line to the 911 operator is not open to enable a pass through or bypass call regardless of the state of the telephone line 32, then the remote 911 call application again establishes a connection with the controller board application of the care recipient 22 in box 146 and displays an error message to the remote caller in the caretaker group in box 148 and prompt the concerned member to re-dial.

If the line is open to calling, then decision block 144 allows the procedure to directly begin the 911 phone call at procedure block 150. If the line is clear to contact the 911 operator, the call is made at box 144, and the operator answer at box 150 will receive the emergency call location for the care recipient 22 and at box 152 the remote member of the care taker group 24 is enabled to communicate with the 911 emergency operator and relay details of the emergency at the 911 call location of the care recipient 22.

In operation the remote healthcare system 10 utilizes the cloud 12 and the cloud based platform 14 with its servers 16 and applications 18 to deliver a broad-based care platform to a care recipient 22 from multiple members of a caretaker group 24. The primary software applications and database are maintained at the cloud level and the remote monitoring of the care recipient 22 is accessible through conventional browser based software by phone, tablet and computer. The care recipient 22 typically accesses the client applications by tablet. The members of the caretaker group 24 have access depending on the level of authorization with the level determined primarily by the care recipient 22. However, this level of authorization may be determined by the primary caretaker, or the family member having primary responsibility for monitoring the care provided.

Referring now to FIG. 7, the schematic circuit diagram for the chip set 154 is an exemplar of a part of the circuitry 34 of the client controller 28 that operates the volume control feature and the “off the hook” emergency dial feature. The circuit diagram shows the chip set 154 for the switch sub-circuitry 116 of the telephone control module 114 and for the audio gain sub-circuitry 125 of the amplifier module 126. It is to be understood that other chip components, including integrated chips, or conventional electrical circuit elements can be substituted for the chip set shown.

A general 12V DC power supply 156 feeds a step-down voltage transformer chip 158 to power the chips at a 12V, 5V and 3.3V voltage as required by the particular chip. A microcontroller chip 160 controls the telephone control module 114 and the audio amplifier module 126. The microcontroller chip 160 connects to the telephone interface chip 162 by line 164. The telephone interface chip 162 includes the switch sub-circuitry 116 to switch the landline service to an emergency or bypass state as previously described. The line terminals 166 and 168 provide the line in and line out for the two call states for ordinary and emergency calls.

The microcontroller chip 160 also connects to an audio filter and gain control chip 170 by lines 172 and 174. The telephone control module 114 and the audio amplifier module 126 are largely separate and are both controlled by the microcontroller chip 160, but have cross connecting lines 176 and 178 between the telephone interface chip 162 and the gain control chip 170 and the provide the ability to utilize the enhanced volume of the audio amplifier module 126 for use as an annunciator, or loud speaker for telephone calls, for example, in an attempt to contact the care recipient 22 via the caretaker's landline and wireless alternatives.

The audio filter and gain control chip 170 is connected to an audio codec chip 180 by lines 182 and 184 for bringing in the audio signal and passing it to the gain control chip 170 for amplification. The audio codec chip 180 is connected to a USB hub chip 186 by lines 188 and 190 for routing the audio signals from the care recipients connected devices such tablets 60 for amplification in the control box 68. The USB hub chip 186 is connected to the microcontroller chip 160 by lines 192, 194 and 196 (the last broken for clarity). The USB hub chip 186 connects to an in-terminal 198 and an out-terminal 200. The USB in-terminal 198 provides a USB connection to the host computer microcontroller board 85 and the USB out-terminal provides a USB connection to the affected devices, not serviced by the speakerphone board 86. Other components can be added such one or more lamps 202 (one shown) as status indicators for the features described under control of the microcontroller chip 160 through line 204.

The following is a list of the primary chips in the chip set 154 for the exemplar implementation of the described features of the telephone control module 114 and the amplifier module 126 of FIG. 7. The list includes, the element number, the chip description, the manufacturer, and the catalog code.

| | | | |
|---|---|---|---|
| 158 | Power Supply | Texas Instruments | LM26400Y |
| 160 | Microcontroller | Texas Instruments | CC2540 |
| 162 | Telephone Interface | IXYS | CPC5622 |
| 180 | USB Audio Codec | Texas Instruments | PCM2900C |
| 186 | USB Hub | Texas Instruments | TUSB2036 |

It is to be understood that the use of the term, chip, is convenient and descriptive for describing a typical integrated electronic circuit for implementing the features of this invention. Similarly, the use of the term, line, is to define a conductor, such as a circuit line on a printed circuit board or a wire conductor for interconnecting the chip set shown. In the exemplar circuit arrangement shown, the lines are instructive and an attempt to inform those skilled in the art the path to follow. It is understood that implementations of the concepts disclosed may improve upon the hardware described to manifest the healthcare system of this invention.

Using a client controller 28 the Bluetooth enabled health monitoring and home automation devices provide remote control of the care recipient's thermostat, television, lights and other home automation devices by the authorized caregivers. Health data is automatically collected at the time of measurement using wireless Bluetooth compatible health devices including a body composition scale, oximeter, pendant accelerometer, blood pressure monitor, glucometer and other devices that may be added to the system. The measurements are instantly transferred to the cloud database, and the data and analysis tools are immediately available to both the care recipient and the appropriate authorized caretakers of the caretaker group.

Communication between select members of the caretaker group and the care recipient include video calls, video messages and text chat messages. The select member or members of the caretaker group can use an emergency intercom system, including one-way live video and two-way live audio directed to the enhanced volume home tablets to initiate communication. An important feature to be used by an authorized member of the caretaker group when the care recipient is unresponsive or unable to dial 911 is an emergency 911 call that is initiated by the authorized member of the caretaker group, but is directed through the circuitry 34 of the client controller 28 to appear from the emergency responder to come from the care recipient location. In this manner the authorized member of the caretaker group can communicate with the 911 operator with the emergency response being directed to the care recipient location.

Although the detailed description is directed at a single care recipient, it is understood that the remote healthcare system applies to multiple care recipients, for example multiple patients under the primary care of a principal caretaker in a hospital or hospice facility, or the home care of multiple care recipients.

With the care recipient side of the system being on 24/7, and the access to the care recipient being directed by the service provider and preferably being provided in part by multiple members of the caretaker group, effective monitoring and intervention can be initiated by any one of the members of the group or the service provider as authorized. In this manner a robust remote health care system can be tailored to an individual care recipient according to his or her circumstances.

1. In cloud computing, a remote healthcare system that provides healthcare services to one or more care recipients comprising;
a service provider having a cloud-based platform that administers the remote healthcare system, the service provider having cloud access devices that remotely provide controlled access to the cloud-based platform as a care provider to the care recipient;
a care recipient having a remote location from the service provider, the care recipient having a central controller at the location of the care recipient that communicates with the cloud-based platform and the care provider, and, the care recipient having a telephone landline connected to the care recipient controller, the telephone landline having a connected telephone and at least one health monitoring sensor,
wherein the care recipient central controller is operationally connected to the care recipient landline and to the at least one health monitoring sensor that generates health data of the care recipient and transmits the health data to the cloud-based platform, and wherein the central controller of the care recipient has switch circuitry that on a remote telephone call to the telephone of the care recipient by the care provider, switches to a bypass connection on encountering an inaccessible line to the telephone of the care provider and permits the remote care provider caller to dial 911 from the apparent location of the care recipient.

2. The remote healthcare system of claim 1 wherein the service provider includes a caretaker having authorized access to the cloud-based platform of the service provider and a level of remote access to the care recipient controller.

3. The remote healthcare system of claim 1 wherein the service provider includes a group of caretakers, the group of caretakers having caretaker members, each caretaker member having a level of authorized access to the cloud-based platform of the service provider and a level of remote access to the care recipient controller.

4. The remote healthcare system of claim 3 wherein the level of authorized access for each caretaker member may be different.

5. The remote healthcare system of claim 4 wherein the level of authorized access for each caretaker member is determined by the care recipient.

6. The remote healthcare system of claim 1 wherein the care recipient central controller is operationally connected to multiple health monitoring sensors and to at least one controlled appliance.

7. The remote healthcare system of claim 1 wherein the care recipient central controller has at least one audio speaker and amplifier circuitry that controls the volume of the at least one audio speaker.

8. The remote healthcare system of claim 1 wherein the care recipient central controller includes a display screen with a programmable user interface having a matrix of user-friendly icons.

9. The remote healthcare system of claim 1 wherein the caretaker has at least one remote access device for accessing the care recipient central controller, the at least one access device having a display screen with a list of user-friendly icons representing portals to features depicted by the user-friendly icons.

10. The remote healthcare system of claim 3 wherein the members of the caretaker group each have at least one remote access device for accessing the care recipient central controller the at least one remote access device having a display screen with user-friendly icons representing portals to features depicted by the user-friendly icons.

11. The remote healthcare system of claim 1 having a plurality of care recipients.

12. The remote healthcare system of claim 3 having a plurality of care recipients, each care recipient having a plurality of caretakers.

13. In a remote healthcare system that utilizes cloud computing and includes a service provider having a cloud-based platform that administers remote healthcare to at least one care recipient remote from the service provider, the remote care recipient having a central controller at the location of the care recipient and a landline with a line to a telephone connected to the landline where the care recipient central controller has switching circuitry, the method of remotely accessing the landline of the care recipient by a remote telephone caller authorized by the service provider to call the telephone of the care recipient and remotely dial an emergency 911 call that appears to come from the location of the care recipient comprising the steps of:
accessing the landline and telephone of the care recipient by a remote telephone caller authorized to initiate an emergency 911 call remotely;
determining if the connected telephone of the care recipient is available for a call;
switching the remote telephone caller to a landline connection to the care recipient central controller when the line to the care recipient's telephone is unavailable;
initiating an emergency 911 call to a 911 operator through the central controller; and,
connecting the call to the 911 operator wherein the call from the remote telephone caller appears to come from the location of the care recipient for an emergency response at the care recipient's location.

14. The method of remotely accessing the landline of the care recipient by a remote telephone caller authorized by the service provider to call the telephone of the care recipient of claim 13, wherein the step of switching the remote telephone caller to the landline automatically bypasses the line to the telephone of the care recipient.

15. The method of remotely accessing the landline of the care recipient by a remote telephone caller authorized by the service provider to call the telephone of the care recipient of claim 14, wherein the step of determining if the connected telephone is unavailable, the step of notifying the remote telephone caller that the line to the telephone of the care recipient is unavailable.

16. The method of remotely accessing the landline of the care recipient by a remote telephone caller authorized by the service provider to call the telephone of the care recipient of claim 13 including after the step of initiating an emergency 911 call to a 911 operator, the step of determining if the connection to the 911 operator was not successful.

17. The method of remotely accessing the landline of the care recipient by a remote telephone caller authorized by the service provider to call the telephone of the care recipient of claim 16, the following step of notifying the remote telephone caller that the connection to the operator was not successful and instructing the remote telephone caller to call again.

18. The method of remotely accessing the landline of the care recipient by a remote telephone caller authorized by the service provider to call the telephone of the care recipient of claim 13, wherein the central controller of the care recipient has in addition, an audio amplifier and audio speakers, wherein after the step of switching the remote telephone caller to a landline connection to the care recipient central controller when the line to the care recipient's telephone is unavailable, the step of amplifying the audio of the remote caller by the audio amplifier and audio speakers before initiating an emergency 911 call to a 911 operator through the central controller.

19. The method of remotely accessing the landline of the care recipient by a remote telephone caller authorized by the service provider to call the telephone of the care recipient and initiate a remote 911 emergency call of claim 13, wherein initiating an emergency 911 call to a 911 operator through the central controller is automatically performed by the care recipient central controller.

20. The method of remotely accessing the landline of the care recipient by a remote telephone caller authorized by the service provider to call the telephone of the care recipient and initiate a remote 911 emergency call of claim 13, wherein the remote telephone caller authorized by the service provider to call the telephone of the care recipient and remotely dial an emergency 911 call is one of a plurality of caretakers having different levels of access to the care recipient central controller for initiating select features of the remote healthcare administered by the service provider that has the cloud-based platform.
